(19) United States
(12) Patent Application Publication
(10) Pub. No.: US 2003/0206631 A1
(43) Pub. Date: Nov. 6, 2003

(54) Method and apparatus for scrambling program data for furture viewing

(76) Inventor: Brant L. Candelore, Escondido, CA (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/771,363

(22) Filed: Jan. 26, 2001

Related U.S. Application Data
(60) Provisional application No. 60/213,121, filed on Jun. 22, 2000.

(51) Int. Cl. H04N 7/167

(52) U.S. Cl. 380/210

(57) ABSTRACT

A method for managing program data includes deriving a code word from an entitlement control message in the program data. The code word is re-scrambled with a local key. The code word that was re-scrambled with the local key is inserted into the entitlement control message.

### CROSS-REFERENCE TO RELATED APPLICATION

This application claims the benefit of the filing date of the Provisional U.S. patent application entitled “A METHOD AND APPARATUS FOR SCRAMBLING PROGRAM DATA FOR FUTURE VIEWING”, application Ser. No. 60/213,121, filed Jun. 22, 2000.

### FIELD OF THE INVENTION

The present invention relates to program viewing units such as set top boxes used in entertainment systems. More specifically, the present invention relates to a method and apparatus for scrambling program data such that the program data may be descrambled for viewing at a future time without experiencing the problems associated with key or rights expiration.

### BACKGROUND OF THE INVENTION

Service providers, such as terrestrial broadcast, cable, and direct broadcast satellite (DBS) companies, regulate program data delivered to viewers by encoding the program data using a variety of key delivery methods. A common key delivery method involves scrambling the content in program data with content keys. Content scrambling keys are also called “control words”. In this method, the content in the program data may be scrambled using control words that may change periodically over time during the broadcast. The control words are typically derived from other keys and access criteria delivered in entitlement control messages (ECM) in the program data. Proper processing of ECMs is typically accomplished by receiving an entitlement management messages (EMM) ahead of time with service keys, if applicable, and service duration rights. In order to descramble the content, the appropriate EMM must first be processed to obtain the service keys and rights, then the ECMs must be processed allowing the proper control words to be generated and applied to descramble the content.

Viewers may be allowed to record copy protected program data with content in a scrambled format and have the content descrambled and displayed at a later time. Program viewing units such as set top boxes may be designed to regulate the descrambling of the recorded content in the program data such that a record of the descrambling may be made and reported to the service providers. This allows the service providers to monitor the usage of program data by viewers and to bill the viewers. Program viewing units may be configured with key management functions that support special revenue features such as pay-per-view, pay-per-play, pay-per-time, and other features.

A drawback of the current key delivery methods is that the service providers typically change the service keys or service duration rights periodically, e.g. usually with the billing cycle of one month. Thus, a program viewing unit may only descramble content in the program data if the current service key or right provided by the service provider is the same as the key or time access criteria used to scramble control words in the recorded program data. Descrambling of content may not be achieved by the program viewing unit after the service key or the service duration period in the recorded program data expires.

### SUMMARY

A method for managing program data according to an embodiment of the present invention is described. A content key or code word is derived by processing the associated entitlement control message in the program data. The code word itself, or parameters used to derive or generate the code word are re-scrambled with a local key. The code word that was re-scrambled with the local key is inserted into the program data as a new entitlement control message replacing the original, and marked accordingly.

Typically, the ECM can be de-multiplexed from a digital stream containing program data. In one embodiment of the present invention, the ECM can be modified by the general purpose CPU in the viewer, and re-multiplexed back into a digital stream that is being recorded.

In an alternative embodiment, the viewer is equipped with special hardware, a control words de-scrambler and re-scrambler unit, which operates on the fields of an ECM as it passes through the hardware, precluding the need for the main CPU to operate on the ECM. This is now discussed further below.

A conditional access unit according to an embodiment of the present invention is described. The conditional access unit includes a control word descrambler unit. The control word descrambler unit descrambles a control word from an entitlement control message with a key. A control word re-scrambling unit is coupled to the control word decrypting unit. The control word re-scrambling unit re-scrambles the control word with a local key. An entitlement control message injector unit is coupled to the control word encrypting unit. The entitlement control message insertor unit inserts the control word that has been encrypted with the local key into the entitlement control message and places it in the program data with the scrambled content.

### BRIEF DESCRIPTION OF THE DRAWINGS

The present invention is illustrated by way of example and not by way of limitation in the figures of the accompanying drawings, in which like references indicate similar elements and in which:

FIG. 1 is a block diagram of an entertainment system according to an embodiment of the present invention;

FIG. 2 is a block diagram of a program viewing unit according to an embodiment of the present invention;

FIG. 3 is a block diagram of a conditional access unit according to an embodiment of the present invention;

FIG. 4 is a block diagram of a local scrambling unit according to an embodiment of the present invention; and

FIG. 5 is a flow chart illustrating a method of managing program data according to an embodiment of the present invention.

### DETAILED DESCRIPTION

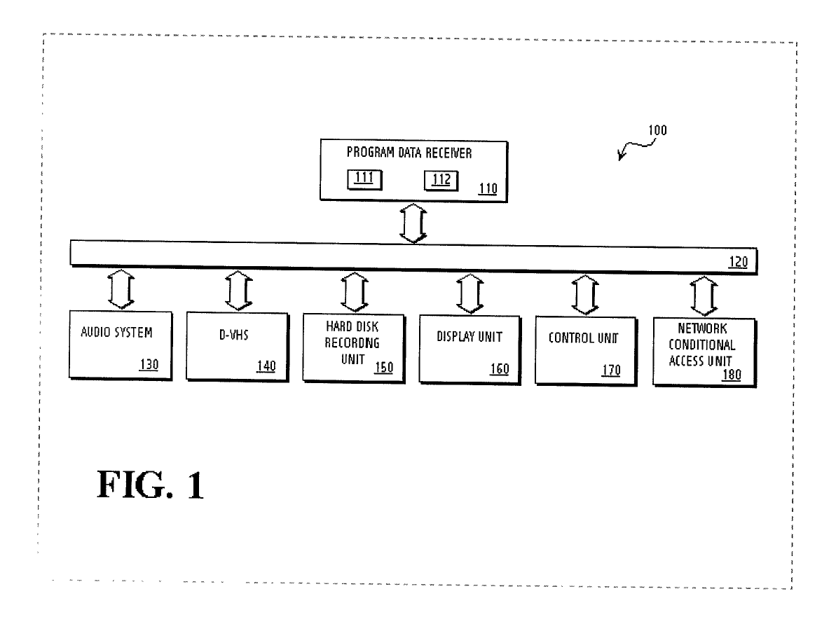

FIG. 1 is a block diagram of an entertainment system 100 according to an embodiment of the present invention. The entertainment system 100 includes a program data receiver 110. The program data receiver 110 receives program data from one or more service providers. A service provider may be, for example, a terrestrial broadcaster, a cable company, a DBS company, or other source.

The program data receiver 110 includes a program viewing unit 111. The program viewing unit 111 operates to process the program data into a viewable format and to regulate access of the program data to other components on the entertainment system 100. The program viewing unit 111 includes a conditional access unit (not shown) that processes the program data using a first key delivery method. The program data may include content, system information (SI), entitlement management messages (EMM), entitlement control messages (ECM), and other data. Content may include audio and video data that may be in a scrambled or clear format. System information may include information on program names, time of broadcast, source, and a method of retrieval and decoding. The system information may also include copy management protection commands that provide program viewing units with guidelines as to how program data may be recorded. For example, the copy management protection commands may include a “copy never” command to indicate that specific program data with content in a clear format should never be copied, or a “copy free” command to indicate that specific program data with content in a clear format may be copied. Entitlement management messages may be used to deliver privileges to the program viewing unit 111 such as rights and keys. An encrypted key, for example, may be a function of the rights granted. Entitlement control messages may be used to regulate access to a particular channel. The entitlement control messages may include control words that may be used to descramble the audio and video data in the content.

The program data receiver 110 includes a viewing unit 112. The viewing unit 112 includes a decoding unit (not shown) and a display unit (not shown). The viewing unit 112 receives program data from the program viewing unit 111. The program data received is in a clear format that allows a program to be viewed. According to an embodiment of the present invention, the program data receiver 110 is a digital television set where the program viewing unit 111 is a built in set top box and the viewing unit 112 is a Motion Picture Experts Group (MPEG) decoder coupled to a display. It should be appreciated that the program data receiver 110 may be implemented with only the program viewing unit 111 as a stand alone set top box. The program data receiver 110 is coupled to a transmission medium 120. The transmission medium 120 operates to transmit data such as program data between the program data receiver 110 and other components in the entertainment system 100.

An audio system 130 may be coupled to the transmission medium 120. The audio system 130 may include speakers and an audio player/recorder such as a compact disk player, mini disk player, or other magneto-optical disk reader/writer that may be used to play or record audio data.

A D-VHS VCR 140 may be coupled to the transmission medium 120. The D-VHS VCR may be used to record analog or digital audio, video, and data transmissions. According to an embodiment of the entertainment system network 100, the D-VHS VCR 140 may be used to record program data on the transmission medium 120.

A hard disk recording unit 150 may be coupled to the transmission medium 120. The hard disk recording unit 150 may be a personal computer system, a stand alone hard disk recording unit, or other hard disk recording device capable of recording analog or digital, audio, video and data transmissions. According to an embodiment of the entertainment system 100, the hard disk recording unit 150 may be used to record program data on the transmission medium 120.

A display unit 160 may be coupled to the transmission medium 120. The display unit 160 may be a high definition television that displays digital and analog signal transmissions, a conventional television set, or other display unit.

A control unit 170 may be coupled to the transmission medium 120. The control unit 170 may be used to coordinate the operation of the components on the entertainment system 100 and other electronic devices. It should be appreciated that FIG. 1 is an exemplary entertainment system 100 and that other components may be added or used in place of the components described.

A network conditional access unit 180 may be coupled to the transmission medium 120. The network conditional access unit 180 may operate to re-scramble program data with content in a clear format such that the entertainment system 100 supports the simultaneous transmission of program data with content in a clear format and program data with content in a scrambled format to components in the entertainment system The network conditional access unit 180 may also be configured to process program data that is coded with a second key delivery method. Conditional access units are typically required to be pre-configured to process program data according to a specified key delivery method. Thus, for every source of program data that uses a different key delivery method, the entertainment system 100 is required to have a corresponding conditional access unit configured to process and descramble the received program data. It should be appreciated that any number of additional network conditional access units may be connected to the transmission medium 120.

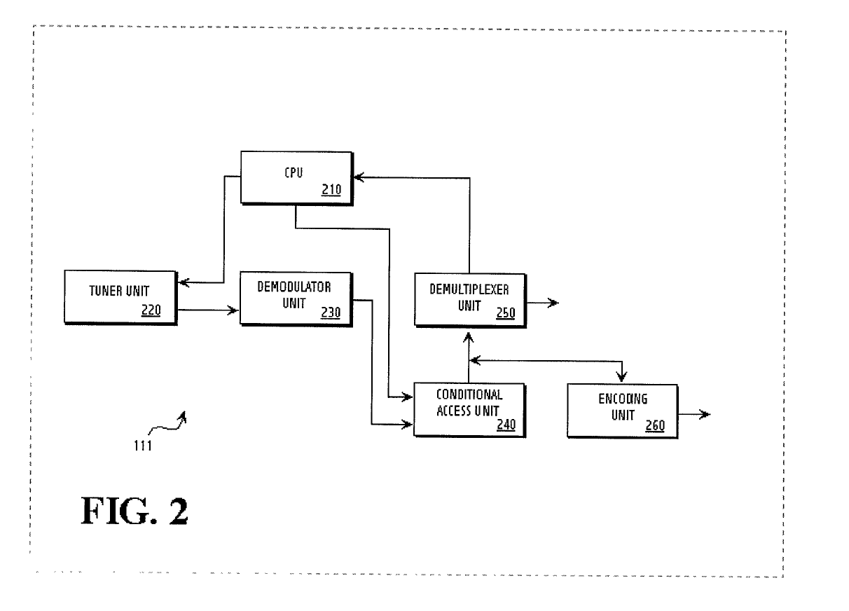

FIG. 2 is a block diagram of a first embodiment of the program viewing unit 111 according to the present invention. The program viewing unit 111 includes a central processing unit (CPU) 210. The CPU 210 supports a graphical user interface that may be displayed on either the viewing unit 112 (shown in FIG. 1) or the display unit 160 (shown in FIG. 1). The graphical user interface allows a user to navigate through various program selections and to select a channel that is to be viewed. The CPU 210 determines a frequency in which a selected channel is broadcasted on and transmits this information to a tuner unit 220. The CPU 210 may also determine a key delivery method used for a channel or source for which program data is delivered from. The CPU 210 may select a conditional access unit in the entertainment system 100 (shown in FIG. 1) that has been configured to process program data coded with that specific key delivery method and coordinate that transmission of the program data to the selected conditional access unit.

The tuner unit 220 is coupled to the CPU 210. The tuner unit 220 operates to select a frequency in the terrestrial, cable, or satellite broadcast in which to receive program data. The program data received from the selected frequency is in the form of signals which are amplified by the tuner unit 220.

A demodulator unit 230 is coupled to the tuner unit 230. The demodulator unit 230 receives the signals from the tuner unit 220 and converts the signals from an analog format to a digital format. The demodulator unit 230 may, for example, perform demodulation of: quadrature amplitude modulation for cable broadcast; quadrature phase shift keying for satellite broadcast; and vestigial side band modulation for terrestrial broadcast. The demodulator unit 230 also performs error correction on the program data received that may be introduced by the channel media.

A conditional access unit 240 is coupled to the CPU 210 and the demodulator unit 230. The conditional access unit 240 receives the program data from the demodulator unit 230. If the program data includes content in a scrambled format, the CPU 210 transmits information regarding a packet identifier where entitlement management messages and entitlement control messages may be found in the program data. The entitlement management messages deliver privileges to the program viewing unit 111 and may deliver a key or information on how to derive a key that may be used to descramble control words. The entitlement control messages regulate access to a particular channel and determines access rights needed to be held by a program viewing unit 111 in order to grant access. The entitlement control messages may include control words that may be in a scrambled format. The control words may be used to descramble audio and video data in the content. According to an embodiment of the present invention, the conditional access unit 240 supports the re-scrambling of control words in the entitlement control message using a local key that is accessible to the program viewing unit 111 and that never expires.

A demultiplexer unit 250 is coupled to the conditional access unit 240. The demultiplexer unit 250 receives the program data from the conditional access unit 240. The demultiplexer unit 250 separates the system information in the program data from the content in the program data. According to an embodiment of the demultiplexer unit 250, the demultiplexer parses the program data for packet identifiers that are associated with system information, audio information, and video information. The demultiplexer unit 250 transmits the system information to the CPU 210 and transmits the audio and video information to the viewing unit 112.

An encoding unit 260 is coupled to the conditional access unit 240. The encoding unit 260 receives the program data from the conditional access unit 240. The encoding unit 260 encodes program data with copy management protection commands that indicate that the program data is not “copy free.” The encoding unit 260 interfaces with the components on the transmission medium 120 (shown in FIG. 1) to determine which components are authorized to decode the encoded program data. The encoding unit 260 may transmit a key to the authorized components for decoding the encoded program data. According to an embodiment of the entertainment system 100, the encoding unit 260 may initiate an authentication process that identifies devices that are authorized to decode encoded program data. According to an embodiment of the present invention, the encoding unit 260 encodes program data transmitted on the transmission medium 120 using the Institute of Electrical and Electronics Engineers 1394 standard (IEEE 1394) encoding algorithm. It should be appreciated, however, that other encoding schemes may be implemented.

The CPU 210, tuner unit 220, demodulator unit 230, conditional access unit 240, demultiplexer unit 250, and encoding unit 260 may be implemented using any known technique or circuitry. In one embodiment of the present invention, the CPU 210, tuner unit 220, demodulator unit 230, conditional access unit 240, demultiplexer unit 250, and encoding unit 260 all reside on a single semiconductor substrate.

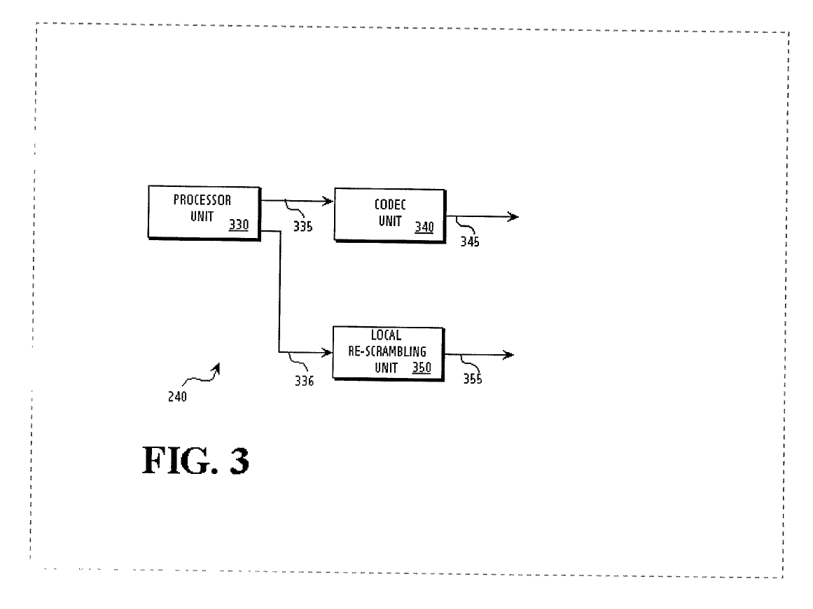

FIG. 3 is a block diagram of the conditional access unit 240 according to an embodiment of the present invention. The conditional access unit 240 includes a processor unit 330. The processor unit 330 receives the program data from the demodulator unit 230 and information regarding a packet identifier that identifies entitlement management in the program data. For program data that includes content in a scrambled format, the processor unit 330 reads the entitlement management messages and derives a key for de-scrambling control words in the entitlement control messages. The processor unit 330 transmits the program data and the key on line 335.

The conditional access unit 240 includes a coder/decoder (codec) unit 340. The codec unit 340 is coupled to the processor unit 330 via line 335. The codec unit 340 receives the key and the program data off of line 335. The codec unit 340 receives information regarding a packet identifier that identifies entitlement control messages in the program data. The codec unit 340 descrambles control words in the entitlement management messages with the key and applies the code word to descramble the content. The codec unit 340 transmits the program data with the content in clear format on line 345.

The conditional access unit 240 includes a local re-scrambling unit 350. The local re-scrambling unit 350 is coupled to the processor unit 330 via line 336. The local re-scrambling unit 350 may be used by the conditional access unit 240 to support special revenue features such as pay-per-view, pay-per-play, pay-per-time, and other features where a viewer wishes to record scrambled program data for display at a later time. The local re-scrambling unit 350 receives the key, the program data, and information regarding packet identifiers that identify entitlement control messages and entitlement management messages off of line 336. The re-scrambling unit 350 descrambles control words in the entitlement control messages with the key and re-scrambles the control words with a local key. The re-scrambling unit 350 replaces the key in the entitlement management message with the local key such that future de-scrambling of the control words would be performed with the local key. The re-scrambling unit 350 transmits the entitlement management message with the local key on line 355.

The network conditional access unit 180 (shown in FIG. 1) may be implemented with the conditional access unit 240 described in FIG. 3. In addition to performing the functionalities described above, the codec unit 340 for the network conditional access unit 180 would have the additional functionality of decoding program data encoded by the encoding unit 260 (shown in FIG. 2) and re-scrambling program data that is in a clear format. According to an embodiment of the present invention, the codec unit 340 re-scrambles the content in the program data with the original key that the program data was scrambled with. According to an alternate embodiment of the present invention, the codec unit 340 re-scrambles the content in the program data using a local key. A local key may be a key unique to the entertainment system 100. The program data with content that is re-scrambled may be transmitted to the encoding unit 260 (shown in FIG. 2) or to a recording device in the entertainment system 100.

It should be appreciated that the codec unit 340 may process the program data by scrambling the content with the original control words and scramble the control words with the original key, scramble the program data with local control words and keys that are unique to the entertainment system 100, scramble the content with a single local key without using control words, or by using other encoding schemes. It should be appreciated that the processor unit 330 and the codec unit 340, and the local re-scrambling unit 350 may be implemented using any known circuitry or technique.

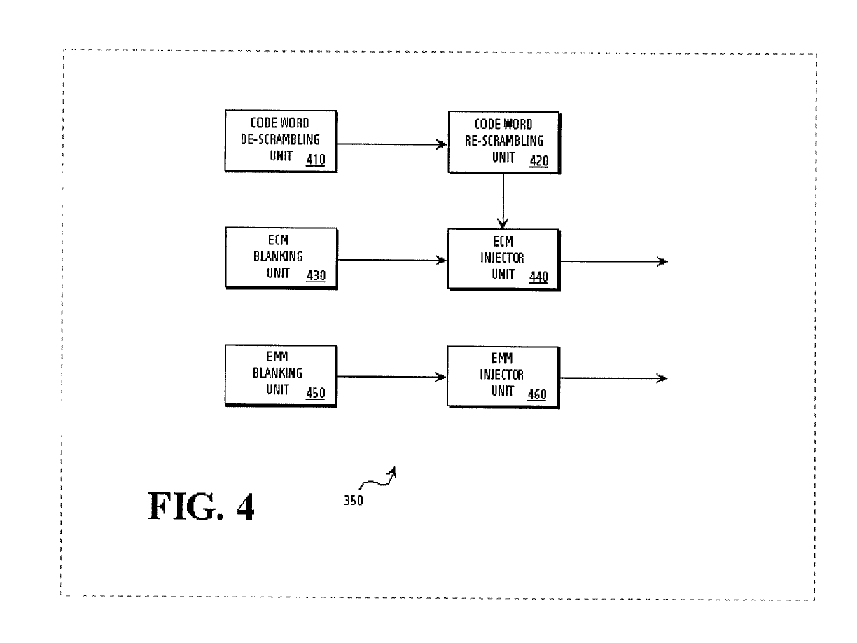

FIG. 4 is a block diagram of a local re-scrambling unit 350 according to an embodiment of the present invention. The local re-scrambling unit 350 includes a code word de-scrambling unit 410. The code word de-scrambling unit 410 receives the key and entitlement control messages from the processor unit 330 (shown in FIG. 3). The code word de-scrambling unit 410 descrambles a control word from the entitlement control message with the key.

A code word re-scrambling unit 420 is coupled to the code word descrambler unit 410. The code word re-scrambling unit 420 receives the descrambled code word from the code word descrambler unit 410. The code word re-scrambling unit 420 unit re-scrambles the descrambled code word with a local key.

The local re-scrambling unit 350 also includes an entitlement control message blanking (ECM) unit 430. The entitlement control message blanking unit 430 receives the entitlement control message from the processor unit 330. The entitlement control message blanking unit 430 erases or “blanks” data related to the control word in the entitlement control message. According to an embodiment of the present invention, the entitlement control message blanking unit 430 writes dummy variables such as zeros or ones, or other dummy variables into fields where control words or scrambled control words are written.

An entitlement control message (ECM) injector unit 440 is coupled to the entitlement control message blanking unit 430 and the code word re-scrambling unit 420. The entitlement control message injector unit 440 receives the entitlement control message that has been blanked by the entitlement control message blanking unit 430 and the code word that has been re-scrambled with the local key from the code word re-scrambling unit 420. The entitlement control message injector unit 440 injects the control word that has been re-scrambled with the local key into the entitlement control message.

The local re-scrambling unit 350 also includes an entitlement management message (EMM) blanking unit 450. The entitlement management message blanking unit 450 receives the entitlement management message from the processor unit 330. The entitlement management message blanking unit 450 erases or “blanks” data related to the key in the entitlement management message. According to an embodiment of the present invention, the entitlement management message blanking unit 450 writes dummy variables such as zeros or ones, or other dummy variables into fields where the key or information related to the key is written.

An entitlement management message (EMM) injector unit 460 is coupled to the entitlement management message blanking unit 450. The entitlement management message injector unit 460 receives the entitlement management message that has been blanked by the entitlement management message blanking unit 450 and injects the entitlement management message with the local key.

The code word de-scrambling unit 410, code word re-scrambling unit 420, entitlement control message blanking unit 430, entitlement control message injector unit 440, entitlement management message blanking unit 450, and entitlement management message injector unit 460 may be implemented using any known circuitry or technique. In an embodiment of the local re-scrambling unit 350, the code word de-scrambling unit 410, code word re-scrambling unit 420, entitlement control message blanking unit 430, entitlement control message injector unit 440, entitlement management message blanking unit 450, and entitlement management message injector unit 460 all reside on a single semiconductor substrate.

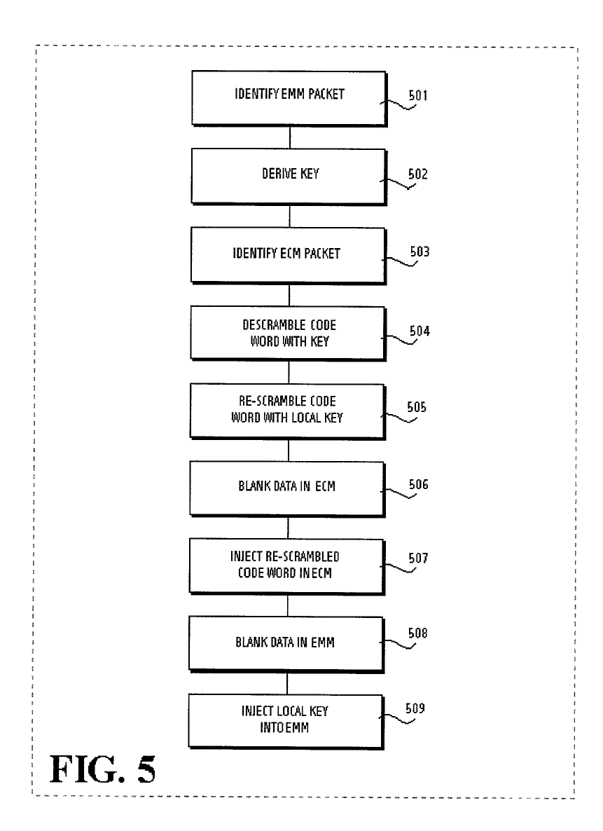

FIG. 5 is a flow chart illustrating a method for managing program data according to an embodiment of the present invention. At 501, a packet in the program data with an entitlement management message (EMM) is identified. According to an embodiment of the present invention, identifying the packet with the entitlement management message may be achieved by sorting program data according to packet identifiers.

At 502, a key is derived from data in the entitlement management message.

At 503, a packet in the program data with the entitlement control message is identified. According to an embodiment of the present invention identifying the packet with the entitlement management message is achieved by sorting program data according to packet identifiers.

At 504, a code word in the entitlement control message is descrambled with the key.

At 505, the code word is re-scrambled using a local key.

At 506, data in the entitlement control message relating to the control word is blanked.

At 507, the code word that was re-scrambled with the local key is injected into the entitlement control message.

At 508, data in the entitlement management message relating to the key is blanked.

At 509, the local key is injected into the entitlement management message.

It should be appreciated that some of the steps described in FIG. 5 may be performed in a different order.

In the foregoing description, the invention is described with reference to specific exemplary embodiments thereof. It will, however, be evident that various modifications and changes may be made thereto without departing from the broader spirit and scope of the present invention as set forth in the claims. The specification and drawings are accordingly to be regarded in an illustrative rather than in a restrictive sense.

What is claimed is:

1. A method for managing program data, comprising:
descrambling content in the program data; and
re-scrambling the content with a local key for future access to the content.

2. The method of claim 1 further comprising encrypting the local key with a unit key and inserting the encrypted key into the program data for future access.

3. The method of claim 1 where the local key is a locally generated random number.

4. A method for managing program data, comprising:
deriving a code word needed to descramble content in the program data;
re-scrambling the code word with a local key; and
inserting the code word that was re-scrambled with the local key into the program data for future access to the content.

5. The method of claim 4 further comprising inserting modified access criteria in addition to the re-scrambled code word.

6. The method of claim 4 further comprising encrypting the local key with a unit key and inserting the encrypted key into the program data for future access.

7. The method of claim 4 where the local key is a locally generated random number.

8. The method of claim 4 wherein the process, once initialized, is performed essentially without CPU intervention.

9. The method of claim 6 further comprising packaging the encrypted key as an entitlement management message prior to insertion into the program data for future access.

10. A method for managing program data, comprising:
descrambling parameters used to derive a code word needed to descramble content in the program data;
re-scrambling the parameters with a local key; and
inserting the parameters that were re-scrambled with the local key into the program data for future access to the program data.

11. The method of claim 10 wherein some of the parameters are modified.

12. The method of claim 10 further comprising encrypting the local key with a unit key and inserting the encrypted key into the program data for future access.

13. The method of claim 10 where the local key is a locally generated random number.

14. The method of claim 12 further comprising packaging the encrypted key that as an entitlement management message prior to insertion into the program data for future access.

15. The method of claim 4 further comprising deriving a code word from an entitlement control message, replacing certain fields of the entitlement control message with new parameters and the code word that was re-scrambled with the local key, and replacing the entitlement control message with the modified version of the entitlement control message in the program data.

16. The method of claim 15 wherein the method, once initialized, is performed essentially without CPU intervention.

17. The method of claim 4 further comprising identifying a packet with an entitlement management message.

18. The method of claim 17 further comprising blanking data in the entitlement management message.

19. The method of claim 17 further comprising inserting the local key into the entitlement management message.

20. The method of claim 14 further comprising deriving the key from the entitlement management message.

21. A computer-readable medium having stored thereon a sequence of instructions, the sequence of instructions including instructions which, when executed by a processor, causes the processor to perform a method comprising:
deriving a code word in an entitlement control message in program data with a key;
re-scrambling the code word with a local key; and
inserting the re-scrambled code word into the entitlement control message.

22. The computer readable medium of claim 21, further comprising instructions which, when executed by the processor, causes the processor to blank data in the entitlement control message before inserting the code word.

23. The computer readable medium of claim 22, further comprising instructions which, when executed by the processor, causes the processor to perform identifying a packet with the entitlement control message.

24. The computer readable medium of claim 23, wherein identifying the packet with the entitlement control message comprises sorting the program data according to packet identifiers.

25. The computer readable medium of claim 21, further comprising instructions which, when executed by the processor, causes the processor to perform identifying a packet with an entitlement management message.

26. The computer readable medium of claim 25, further comprising instructions which, when executed by the processor, causes the processor to perform blanking data in the entitlement management message.

27. The computer readable medium of claim 25, further comprising instructions which, when executed by the processor, causes the processor to perform inserting the local key into the entitlement management message.

28. The computer readable medium of claim 25, further comprising instructions which, when executed by the processor, causes the processor to perform deriving the key from the entitlement management message.

29. A conditional access unit, comprising:
a control word descrambler unit that descrambles a control word from an entitlement control message with a key;
a control word re-scrambling unit, coupled to the control word descrambler unit, that re-scrambles the control word with a local key; and
a entitlement control message injector unit, coupled to the control word re-scrambler unit, that injects the control word that has been re-scrambled with the local key into the entitlement control message.

30. The conditional access unit of claim 29, wherein the conditional access unit is managed essentially without CPU involvement.

31. The conditional access unit of claim 29 further comprising an entitlement control message blanking unit, coupled to the entitlement control message injector unit, that blanks data in the entitlement control message before transmitting the entitlement control message to the entitlement control message injector unit.

32. The conditional access unit of claim 29, further comprising an entitlement management message injector unit, that injects the local key into an entitlement management message.

33. The conditional access unit of claim 32, further comprising an entitlement management message blanking unit, coupled to the entitlement management message injector unit, that blanks data in the entitlement management message before transmitting the entitlement management message to the entitlement management message injector unit.
